(19) United States
(12) Patent Application Publication
(10) Pub. No.: US 2012/0115658 A1
(43) Pub. Date: May 10, 2012

(54) ELASTIC DRIVE BELT, IN PARTICULAR RIBBED V-BELT, HAVING REDUCED LOSS OF TENSION

(76) Inventors: Henning Kanzow, Hannover (DE); Falk Lorenz, Seelze (DE); Tim Fise, Hannover (DE)

(21) Appl. No.: 13/308,099

(22) Filed: Nov. 30, 2011

Related U.S. Application Data
(63) Continuation of application No. PCT/EP2010/057312, filed on May 27, 2010.

(30) Foreign Application Priority Data
Jul. 1, 2009 (DE) 10 2009 026 077.3

(51) Int. Cl. F16G 5/08; F16G 5/16

(52) U.S. Cl. 474/238; 474/260

(57) ABSTRACT

A drive belt has a foundational body made of a polymeric material with elastic properties including a top ply as belt backing and a substructure having a force transmission zone. At least one tensile strand in cord construction is embedded in the drive belt. The tensile strand is completely or partially made of a polyethylene terephthalate (PET), wherein the PET is formed of a yarn associated with the following yarn and cord parameters: a cord linear density of ≦3600 dtex; a yarn hot air thermal shrinkage ≦5% after 2 minutes at 177° C. and at a pre-tension of 0.0005 N/dtex; a corresponding yarn force of ≧3.4 cN/dtex at an elongation of 5% at 25° C. and at a pretension of 0.0005 N/dtex; and a cord hot air thermal shrinking force of ≧0.12 cN/dtex in hot air at 160° C. after 10 minutes and at a pre-tension of 0.0005 N/dtex.

### CROSS REFERENCE TO RELATED APPLICATIONS

This application is a continuation application of international patent application PCT/EP 2010/057312, filed May 27, 2010, designating the United States and claiming priority from German application 10 2009 026 077.3, filed Jul. 1, 2009, and the entire content of both applications is incorporated herein by reference.

### FIELD OF THE INVENTION

The invention relates to a drive belt having a foundational body composed of a polymeric material having elastic properties, comprising a top ply as belt backing and also a substructure having a force transmission zone, wherein:

a first variant has at least one tensile strand in cord construction embedded in the foundational body; or,

a second variant interposes between the top ply and the substructure an interply composed of a polymeric material having elastic properties, wherein at least one tensile strand in cord construction is embedded in the interply; or,

a third variant has at least one tensile strand in cord construction forming a cord ply, wherein there is interposed between the cord ply and the top ply and/or between the cord ply and the substructure an interply composed of a polymeric material having elastic properties.

### BACKGROUND OF THE INVENTION

Drive belts, which are also referred to as force transmission belts and which form endless loops in the operational state, can be configured as flat belts, V belts, V-ribbed belts, toothed belts, and clutch belts. V-ribbed belts are of particular importance, for which reference is made to the following patent literature: DE 38 23 157 A1; U.S. Pat. No. 7,128,674; United States patent application publication 2008/0261739; DE 10 2007 044 436 A1; EP 0 590 423 A2; EP 0 737 228 B1; U.S. Pat. No. 6,033,331; EP 0 866 834 B1; U.S. Pat. No. 6,464,607; EP 1 129 308 B1; and, U.S. Pat. No. 3,981,206.

A drive belt's elasticity including flexural elasticity is the result of the foundational body and hence the top ply and the substructure being made of a polymeric material having elastic properties, for which particularly the two groups of materials known as elastomers and thermoplastic elastomers are suitable. Elastomers based on a vulcanized rubber mixture are of particular importance.

The drive belt is provided with at least one embedded tensile strand according to one of the three variants mentioned at the beginning, and it is more particularly two or more tensile strands which form a tensile/strength component ply. A tensile strand in cord construction is of particular importance, in which regard the prior art offers various conceptions of materials. Significant types of materials will now be presented in greater detail.

### Tensile Strand Composed of Polyester (PES)

Automotive applications most frequently utilize V-ribbed belts (VRBs) comprising a tensile strand composed of PES. Typical cord constructions involving PES are 1100 dtex ×2×3 and 1100 dtex ×3×3. Yet such a tensile strand, when embodied in the standard type yarns frequently used, does not exhibit advantageous lengthening behavior. The cords of PES “creep”. That is, they extend plastically. This is often compensated by an automatic tensioning system used in the VRB drive. In recent years, engine producers have increasingly tried to dispense with the costly and heavy tensioning systems, where possible. In a VRB drive without automatic tensioning system, however, belt lengthening causes operational voltage to decrease, which has a very adverse effect on the drive performance of the belt and on its durability. One solution is to replace or retension the belt, an operation for which it is normally necessary to visit a specialist workshop. In the case of a VRB drive with exclusively fixed rollers (“fixed drive”), moreover, simple assembly is scarcely possible because the assembly tensions, which arise when forcing the belt over the disks, are too high on account of the excessively large ExA value (longitudinal stiffness) of the belt. Tensile strand composed of polyamide (PA)

Automotive applications without automatic tensioning system therefore usually employ VRBs comprising a tensile strand composed of PA, particularly in the form of PA6.6 and PA4.6, which are notable for a lower modulus. However, they likewise lose the necessary tension relatively rapidly in belt drives without tensioning system with a high number of rollers under high transmission of power. The possible remedy here is a distinct increase in pre-tensioning. But the bearing stresses associated therewith are usually unacceptable in commercial practice.

A further problem with a PA tensile strand is an excessively high shrinkage in storage. This excessively high shrinkage in storage has hitherto been attempted to be reduced via an ideally tensionless manufacture of belts (U.S. Pat. No. 6,033,331). In commercial practice, however, problems arise again and again with the mountability of such elastic drive belt belts, especially of V ribbed belts because the belts shorten excessively during a long time in storage, as occurs in the replacement market in particular.

### Tensile Strand Composed of Polyether Ether Ketone (PEEK)

A recent proposal is to endow V-ribbed belts in particular with a tensile strand composed of PEEK. A multifilament construction is used here in particular in addition to the cord construction. With regard to textile-technological details in this respect, reference is made to DE 10 2007 044 436 A1. Comparative tests between a PA6.6 tensile strand and a PEEK tensile strand have shown that drive belts comprising a PEEK tensile strand suffer a reduced loss of tension combined with distinctly reduced shrinkage in storage. The running time and hence the operational life of a drive belt with PEEK tensile strand are therefore distinctly greater. However, it is disadvantageous here that the textile material PEEK is distinctly costlier than polyamide or polyester, so that the limits of economic viability are demonstrated here.

The abovementioned materials for the tensile strand in summary reveal common problems with the production of low-modulus drive belts comprising a low-modulus cord as tensile strand, associated with achieving a low drop-off in tension and a low shrinkage in storage as well as a high power transmission ability.

The other alternatives otherwise known among materials, namely steel, aramid, glass fibers and carbon fibers, are unsuitable for elastic VRBs on account of their high-modulus character and their low extensibility.

In general, drive belts cannot be provided arbitrarily wide. To increase power transmission per belt width, therefore, an improvement in the power transmission force of a tensile strand itself is required.

### SUMMARY OF THE INVENTION

Against the background of the overall tensile strand problematics presented here, the invention has for its object to provide a low-modulus drive belt, more particularly a V-ribbed belt, using a low-modulus cord, this object being associated with an increase in operational life from the aspect of a reduced loss of tension and also additionally with the objective of a low shrinkage in storage. In addition, the tensile strand concept associated herewith shall be economical.

This object is achieved when the tensile strand consists completely or partially of a polyethylene terephthalate (PET), wherein the PET is formed of a yarn, associated with the following yarn and cord parameters:
a cord linear density 3600 dtex (features group I);
a yarn hot air thermal shrinkage 5% after 2 minutes at 177° C. and a pre-tension of 0.0005 N/dtex (features group II);
a corresponding yarn force ≧3.4 cN/dtex at an elongation of 5% at 25° C. and a pre-tension of 0.0005 N/dtex (features group III) and also
a cord hot air thermal shrinkage force ≧0.12 cN/dtex in hot air at 160° C. after 10 minutes and at a pre-tension of 0.0005 N/dtex (features group IV).

The yarn parameters (features groups II and III) relate exclusively to the PET as unprocessed yarn—irrespective of whether the tensile strand consists completely or partially of PET. The cord parameters (features groups I and IV) relate not only to a tensile strand formed exclusively of PET but also to a tensile strand in the form of a hybrid system which will be more particularly presented later.

The unprocessed yarn used here for the cord is in accordance with features groups II and III and is a high modulus, low shrinkage (HMLS) PET yarn. Its use for a low-modulus cord is novel and was unforeseeable with respect to the performance effect desired.

The PET yarn under the abovementioned conditions advantageously satisfies the following yarn parameters:
a yarn hot air thermal shrinkage of 4%;
a corresponding yarn force of 3.8 cN/dtex.

A series of tests have shown that it is very advantageous to manufacture a cord using an unprocessed yarn having a hot air thermal shrinkage of 3.9% at 177° C. and also a corresponding force of 4.0 cN/dtex at 5% elongation at 25° C.

Advantageous cord parameters are:
a cord linear density of 2000 dtex to 3500 dtex;
a cord hot air thermal shrinkage force 0.18 cN/dtex;
a braid twist ≧180 tpm, more particularly ≧200 tpm and again more particularly in the range from 200 tpm to 220 tpm;
a cord construction of 900 dtex to 1300 dtex ×1×3 or 900 dtex to 1300 dtex ×1×2, more particularly 1100 dtex ×1×3 or 1100 dtex ×1×2;
a cord twist ≦160 tpm, more particularly ≦135 and more particularly in the range from 90 tpm to 135 tpm.

Some textile-technological terms used herein require the following explanations:
The corresponding force of the yarn as per features group III is the force which corresponds to 5% elongation at 25° C. It can also be referred to as force or load at specified elongation.
The corresponding force as per features group III and also the cord shrinkage force as per features group IV apply the respective force per cord linear density with the dimensional particular cN/dtex. Here “c” means “centi”, i.e., 1/100.
The “tpm” is short for “turns per meter” and is a typical unit in textile technology for twists of any kind.
In the cord construction, the linear density of the braids is reported as nominal fineness, as is customary in textile technology. This is the nominal linear density (as reported by the producer) of the unprocessed yarn used for producing the cord (cf. DIN 53830-3). Owing to twisting and stretching, the actual linear density can differ therefrom.
The cord linear density is the actual linear density (cf. DIN 53830-3) of the textile portion of the cord (bonding layers).

A series of tests in respect of the cord hot air thermal shrinkage force essential to the invention gave values of 0.18 cN/dtex (corresponds to medium stretching of the cord in cord manufacture) to 0.37 cN/dtex (corresponds to high stretching of the cord in cord manufacture).

It is of particular importance for the tensile strand to consist completely of a PET because this gives the best results.

However, it is also possible for the tensile strand to consist partially of PET, provided the majority of quantity is PET. The PET can in this case be mixed with a polyamide (PA), polyimide (PI), aramid, polyvinyl acetal (PVA), polyester (PES), polyether ether ketone (PEEK) or a poly(ethylene 2,6-naphthalate) (PEN) or in a combination of the aforementioned materials. Such textile hybrid materials make it possible to improve for example the adherence of PET to the surrounding polymeric material, in which case a PET/PA hybrid system is particularly suitable because PA is particularly adherence-activatable. The PET fraction within a tensile strand is in the range from 55% by weight to 95% by weight and more particularly in the range from 75% by weight to 95% by weight. What is important with the use of such hybrid concepts is that, compared with a tensile strand formed exclusively of PET, there is no deterioration in the abovementioned cord parameters, at least with regard to cord linear density (features group I) and cord hot air thermal shrinkage force (features group IV).

Further advantageous embodification variants for the drive belt of the present invention will be presented in greater detail as part of the figure description.

### BRIEF DESCRIPTION OF THE DRAWINGS

The invention will now be described with reference to the drawings wherein:

FIG. 1 shows a cross section through a V-ribbed belt in two embodiments (portions A and B);

FIG. 2 shows a further embodiment of a V-ribbed belt in three-dimensional detail; and,

FIG. 3 shows the belt run force behavior of a V-ribbed belt with various tensile strand materials by means of a diagram.

### DESCRIPTION OF THE PREFERRED EMBODIMENTS OF THE INVENTION

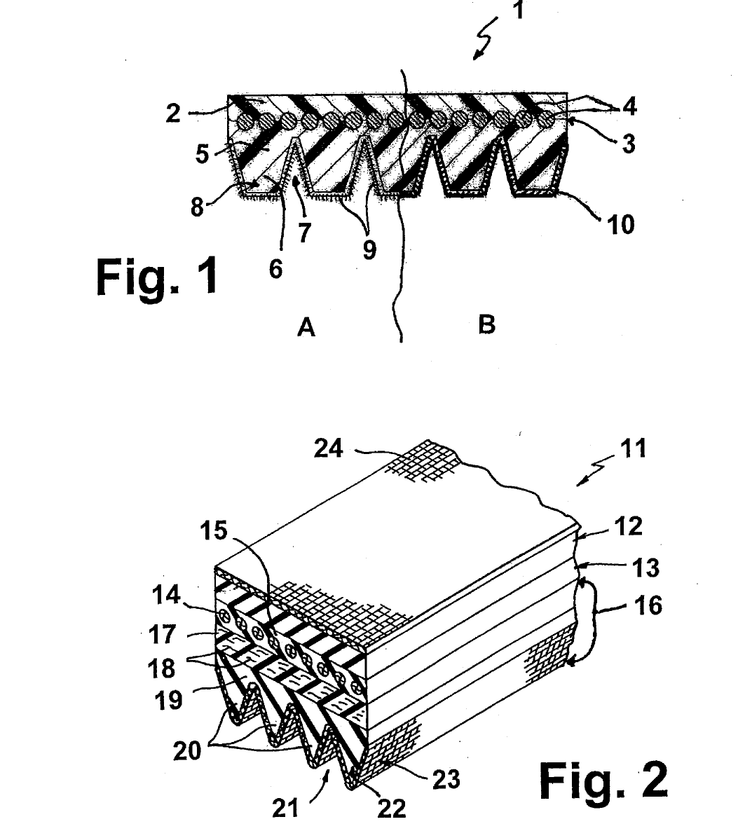

FIG. 1 shows a drive belt 1 in the form of a V-ribbed belt having a top ply 2 as belt backing, a single-ply strength component ply 3 having a parallel arrangement of tensile strands 4 extending in the longitudinal direction and also with a substructure 5. The substructure 5 has a V-shaped rib structure formed of ribs 6 and grooves 7. The substructure comprises the force transmission zone 8.

The top ply 2 and the substructure 5 combine to form as an overall unit the foundational body composed of a polymeric material having elastic properties, more particularly in the form of a vulcanized rubber mixture containing at least one rubber component and mixture ingredients. The rubber component used is more particularly an ethylene-propylene rubber (EPM), an ethylene-propylene-diene monomer rubber (EPDM), (partially) hydrogenated nitrile rubber (HNBR), chloroprene rubber (CR), fluororubber (FKM), natural rubber (NR), styrene-butadiene rubber (SBR) or butadiene rubber (BR), which are uncut or cut with at least one further rubber component, more particularly with one of the aforementioned types of rubber, for example, in the form of an EPM/EPDM or SBR/BR blend. In this connection, EPM or EPDM or an EPM/EPDM blend is of particular importance. The mixture ingredients comprise at least one crosslinker or crosslinker system (crosslinker plus accelerant). Further mixture ingredients usually include a filler and/or a processing aid and/or a plasticizer and/or an antioxidant and also optionally further addition agents, for example, fibers and color pigments. The general state of rubber mixing technology is referenced in this regard. The preferred incorporation of fibers into the rubber mixture will be discussed in more detail later.

The tensile strands 4 here are embedded in the foundational body without interply. Preferably, each tensile strand in cord construction consists of a polyethylene terephthalate (PET). In a further preferred embodiment, the PET can also be mixed with at least one further material, for example, with a polyamide (PA), in which case the PET is the majority material in such a hybrid concept.

Every tensile strand 4 may additionally be endowed with a bonding layer, for example, a resorcinol-formaldehyde latex (RFL). With regard to such or similar bonding concepts reference is made in particular to DE 10 2007 044 436 A1, specifically in connection with the tensile strand material polyether ether ketone (PEEK).

The drive belt 1 within its force transmission zone 8 has a coating 9 or 10 in the form of flock (portion A), for example, with a cotton or aramid flock as described in DE 38 23 157 A1 and U.S. Pat. No. 7,128,674, or in the form of a textile cover ply as described in United States patent application publication 2008/0261739. Textile cover plies are of particular importance, especially in turn in the form of a woven fabric, of a loop-formingly knitted fabric or of a loop-drawingly knitted fabric. In the case of a V-ribbed belt, the textile cover ply is preferably a loop-formingly knitted fabric or a loop-drawingly knitted fabric. Such a coating provides a combination of wear control and noise insulation.

The coating may—in order to fulfill the additional criterion of media resistance, more particularly from the aspect of oil resistance, coupled with good lubricity—be a fluoro plastic, which is more particularly polytetrafluoroethylene (PTFE) and/or polyvinyl fluoride (PVF) and/or polyvinylidene fluoride (PVDF). PTFE is of particular importance. The fluoro plastic may, according to a recent development, consist of a foil, more particularly a PTFE foil, or of a foil assembly, more particularly a PTFE/PA foil, in which case PTFE forms the immediate upper layer in a foil assembly (DE 10 2008 012 044.8). A preferred alternative thereto consists in saturating/sealing a textile cover ply with a fluoro plastic. The additional measure of coating, which can also be used for the top ply 2 (exemplary embodiment as per FIG. 2), leads in conjunction with the novel tensile strand conception to a high operational life for the drive belt.

FIG. 2 then shows a further drive belt 11, likewise in the form of a V-ribbed belt, which comprises a top ply 12, a single-ply strength component ply 13 and a substructure 16 with a V-shaped rib zone 19, formed of ribs 20 and grooves 21. The strength component ply is again formed of individual tensile strands 14 which consist completely or partially of PET. In this regard, the PET textile technology already presented above in more detail is referenced.

The strength component ply 13 and the tensile strands 14 here are completely surrounded by an embedding mixture which forms the interply 15, so that this again produces an effective overall assembly of top ply 12, strength component ply 13 and substructure 16. The interply 15 consists of a polymeric material having elastic properties, preferably again in the form of a vulcanized rubber mixture. In this regard, the same rubber technology as already explained in connection with the top ply and the substructure of the exemplary embodiment as per FIG. 1 applies.

The substructure 16 itself here additionally comprises a further elastic interply 17, more particularly on the basis of the abovementioned rubber mixture, which is reinforced with fibers 18, more particularly with textile fibers. The fibers consist of cotton, cellulose, an aramid, more particularly p-aramid, a polyamide (PA), more particularly PA6 or PA6.6, a polyvinyl acetal (PVA) or a polyethylene terephthalate (PET). The fibers can be present in the form of a pulp or in short fibers. In the case of short fibers, the length is ≦8 mm and more particularly ≦5 mm.

Similarly, the entire substructure 16 and also the top ply 12 and the two interplies 15 and 17 can be reinforced with fibers of the abovementioned type.

In the exemplary embodiment as per FIG. 2, not only the top ply 12 but also the force transmission zone 22 of substructure 16 is provided with a coating 23 or 24, respectively, in the form of a textile cover ply. With regard to the materials technology of the coating in this regard, reference is made to the observations made in connection with the drive belt as per FIG. 1.

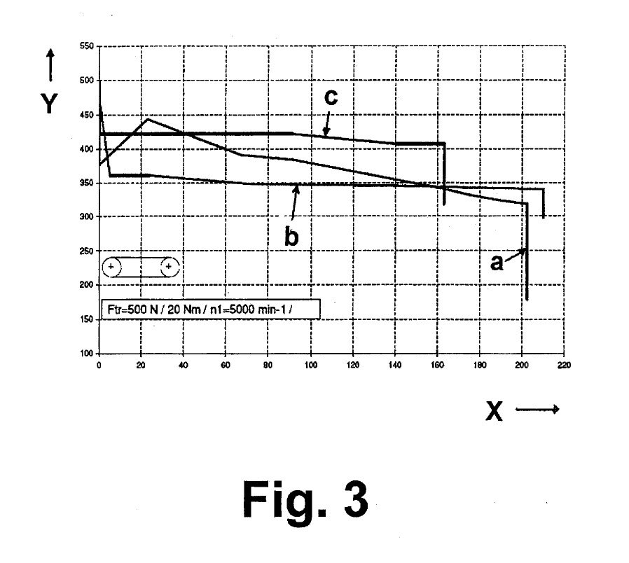

The diagram of FIG. 3 records the result of the belt run force behavior of three V-ribbed belts (VRBs) with different tensile strand conception, where the abscissa X indicates the running time in hours and the ordinate Y indicates the belt run force in N.

All three VRB types (a, b, c) based on an EPDM mixture were produced in the same way using the same mold in the molding process. With regard to the tensile strand, the following material aspects apply:
VRB (a) Tensile strand exclusively composed of PA6.6
   Cord construction 940 dtex ×2×3
   Braid twist/cord twist 150/125 tpm
   Package slope 100 threads/100 mm width
VRB (b) Tensile strand exclusively composed of PEEK
   Cord construction 1230 dtex ×1×4
   Braid twist/cord twist 200/100 tpm
   Package slope 100 threads/100 mm width
VRB (c) Tensile strand exclusively composed of PET

Cord construction 1100 dtex ×1×3
Braid twist/cord twist 210/100 tpm
Package slope 100 threads/100 mm width

The belts were tested on a two-disk test stand (disk diameter 120 mm). The belts were further pre-tensioned at room temperature to a belt run tension of 500 N. The test, which took about 200 hours, was performed at an ambient temperature of 120° C. and a rotary speed of 5000 min⁻¹ and a torque of 20 Nm, with the following result:
Belts with PA6.6 tensile strand have a higher tension in the first 160 hours on account of the temperature-based shrinkage force, but this higher tension rapidly drops off linearly and in the further course will cause the belt run tension to decrease below the slippage limit (curve a).
Belts with PEEK tensile strand keep tension virtually constant after the run-in period. Their potential running time is therefore distinctly greater (curve b).

The best tension behavior shown by a belt is PET tensile strand (curve c).

The VRBs (a, b, c) were stored at room temperature for 270 days. The following data were determined with regard to shrinkage in storage:
VRB (a) 0.9% shrinkage in storage
VRB (b) 0.2% shrinkage in storage
VRB (c) 0.4% shrinkage in storage

The VRB (b) with PEEK tensile strand shows the best value for the shrinkage in storage test, but having regard to the belt run force behavior and also the economics, the PET tensile strand conception breaks significant new ground.

As already illustrated by the exemplary embodiments as per FIGS. 1 to 3, the use of the novel PET tensile strand conception will focus on a VRB. This VRB is used more particularly in a VRB drive without automatic tensioning system.

However, low-modulus drive belts are sometimes also operated with an automatic tensioning system because this can bring about a reduced noise level with some engines. Short lengthening following running is also desirable here because it facilitates the layout of the tensioner and allows greater design freedom in the engineering of the VRB drive.

The table which follows, then, summarizes the methods of measurement together with explanations.

Methods of measurement

| | | | | Notes |
|---|---|---|---|---|
| | | Measuring | Measuring | concerning |
| Designation | Unit | instrument | method | procedure (e) |
| Linear density | dtex | Sartorius | DIN | (f) |
| | | LA2305 | 53830 | |
| | | balance | (Part 3) | |
| Twist | tpm | Zweigle | DIN ISO | (f) |
| | (m⁻¹) | D314 twist | 2061 | |
| | | counter | | |
| Hot air | N | Tesrite | DIN | (g) |
| thermal | | Mark 5 | 53866 | |
| shrinkage | | shrinkage | (Part 12) | |
| force (HASF) | | meter | | |
| Hot air | % | Tesrite | ASTM | (h) |
| thermal | | Mark 5 | D 4974-04 | |
| shrinkage | | shrinkage | | |
| (HAS) | | meter | | |
| Force at 5% | N | Zwick 1445 | ASTM | (i) |
| elongation | | tensile | D 885-07 | |
| (FASE) | | tester | | |
| Hot air | N/dtex | (c) | | (c) |
| thermal | | | | |
| shrinkage | | | | |
| force per | | | | |
| linear density | | | | |
| (a) | | | | |
| Force per | N/dtex | (d) | | (d) |
| linear density | | | | |
| at 5% | | | | |
| elongation (b) | | | | |

Explanations for table:
(a) shrinkage force per unit linear density
(b) force at 5% elongation per unit linear density
(c) contributed from hot air thermal shrinkage force and linear density
(d) contributed from force at 5% elongation and linear density
(e) may differ from standard
(f) The samples are stored on the package in an EN ISO 139 standard atmosphere (20° C., relative humidity 65%) for 24 hours and then measured without drying.
(g) The samples are stored on the package in an EN ISO 139 standard atmosphere (20° C., relative humidity 65%) for 24 hours and then measured without drying. The measurement takes place after 10 minutes at 160° C. The pre-tension is 0.0005 N/dtex for clamping the yarn.
(h) The samples are stored on the package in an EN ISO 139
standard atmosphere (20° C., relative humidity 65%) for 24 hours and then measured without drying. The measurement takes place after 2 minutes at 177° C.
(i) The samples are stored on the package in an EN ISO 139 standard atmosphere (20° C., relative humidity 65%) for 24 hours and then measured without drying. The pre-tension is 0.0005 N/dtex.

It is understood that the foregoing description is that of the preferred embodiments of the invention and that various changes and modifications may be made thereto without departing from the spirit and scope of the invention as defined in the appended claims.

### List of Reference Numerals

### (Part of Description)

1 drive belt or V-ribbed belt (VRB)
2 top ply as belt backing
3 strength component ply
4 tensile strand
5 substructure
6 ribs
7 grooves
8 force transmission zone
9 coating in the form of flock (portion A)
10 coating in the form of a textile cover ply (portion B)
11 drive belt or V-ribbed belt
12 top ply as belt backing
13 strength component ply
14 tensile strand
15 interply in the form of an embedding mixture
16 substructure
17 interply
18 fibers
19 V-shaped rib zone
20 ribs
21 grooves
22 force transmission zone
23 coating in the form of a textile cover ply
24 coating in the form of a textile cover ply
X abscissa: running time in hours
Y ordinate: belt run force in N
a VRB with tensile strand of PA6.6
b VRB with tensile strand of PEEK
c VRB with tensile strand of PET

What is claimed is:

1. A drive belt having a foundational body composed of a polymeric material having elastic properties, comprising a top ply as belt backing and also a substructure having a force transmission zone, wherein:
a first variant has at least one tensile strand in cord construction embedded in the foundational body; or,
a second variant interposes between the top ply and the substructure an interply composed of a polymeric material having elastic properties, wherein at least one tensile strand in cord construction is embedded in the interply; or, a third variant has at least one tensile strand in cord construction forming a cord ply, wherein there is interposed between the cord ply and the top ply and/or between the cord ply and the substructure an interply composed of a polymeric material having elastic properties;
wherein the tensile strand comprises or consists of a polyethylene terephthalate (PET), wherein the PET is formed of a yarn, associated with the following yarn and cord parameters:
a cord linear density 3600 dtex;
a yarn hot air thermal shrinkage 5% after 2 minutes at 177° C. and a pre-tension of 0.0005 N/dtex;
a corresponding yarn force 3.4 cN/dtex at an elongation of 5% at 25° C. and a pre-tension of 0.0005 N/dtex; and also, a cord hot air thermal shrinkage force 0.12 cN/dtex in hot air at 160° C. after 10 minutes and at a pre-tension of 0.0005 N/dtex.

2. The drive belt according to claim 1, wherein the first variant has two or more tensile strands embedded in the foundational body in a parallel arrangement, or the second variant has two or more tensile strands embedded in the interply in a parallel arrangement, or the third variant has two or more tensile strands in a parallel arrangement forming the cord ply, wherein every tensile strand in cord construction comprises or consists of a PET in all three variants.

3. The drive belt according to claim 2, wherein the tensile strands are disposed to form a single ply.

4. The drive belt according to claim 1, wherein the tensile strand consists of PET.

5. The drive belt according to claim 1, wherein the tensile strand consists partially of PET by being mixed with at least one further material, with the majority by weight of the mixture being PET.

6. The drive belt according to claim 5, wherein the PET is mixed with a member from the group consisting of polyamide (PA), polyimide (PI), aramid, polyvinyl acetal (PVA), polyester (PES), polyether ether ketone (PEEK), and a poly(ethylene 2,6-naphthalate) (PEN), or a combination thereof.

7. The drive belt according to claim 5, wherein the PET fraction within a tensile strand is at least 55% by weight.

8. The drive belt according to claim 7, wherein the PET fraction within a tensile strand is in the range from 55% by weight to 95% by weight.

9. The drive belt according to claim 7, wherein the PET fraction within a tensile strand is in the range from 75% by weight to 95% by weight.

10. The drive belt according to claim 1, wherein the cord linear density is in the range from 2000 dtex to 3500 dtex.

11. The drive belt according to claim 1, wherein the yarn hot air thermal shrinkage is 4%.

12. The drive belt according to claim 1, wherein the corresponding yarn force is 3.8 cN/dtex.

13. The drive belt according to claim 1, wherein the cord hot air thermal shrinkage force is 0.18 cN/dtex.

14. The drive belt according to claim 1, wherein the tensile strand has a cord construction of 900 dtex to 1300 dtex ×1×3 or 900 dtex to 1300 dtex ×1×2.

15. The drive belt according to claim 14, wherein the tensile strand has a cord construction of 1100 dtex ×1×3 or 1100 dtex ×1×2.

16. The drive belt according to claim 1, wherein the tensile strand has a braid twist 180 tpm.

17. The drive belt according to claim 16, wherein the braid twist is 200 tpm.

18. The drive belt according to claim 16, wherein the braid twist is in the range from 200 tpm to 220 tpm.

19. The drive belt according to claim 1, wherein the tensile strand has a cord twist of 160 tpm.

20. The drive belt according to claim 19, wherein the cord twist is 135 tpm.

21. The drive belt according to claim 19, wherein the cord twist is in the range from 90 tpm to 135 tpm.

22. The drive belt according to claim 1, wherein the polymeric material of the top ply and/or of the substructure and/or of the interply for the tensile strand and/or optionally a further interply is a vulcanized rubber mixture comprising at least one rubber component and also mixture ingredients.

23. The drive belt according to claim 22, wherein the rubber component is selected from the group consisting of ethylene-propylene rubber (EPM), ethylene-propylene-diene monomer rubber (EPDM), (partially) hydrogenated nitrile rubber (HNBR), chloroprene rubber (CR), fluororubber (FKM), natural rubber (NR), styrene-butadiene rubber (SBR), and butadiene rubber (BR), which are used uncut or cut with at least one further rubber component.

24. The drive belt according to claim 23, wherein the rubber component is selected from the group consisting of EPM, EPDM, and an EPM-EPDM blend.

25. The drive belt according to claim 1, wherein the top ply and/or the substructure and/or the interply for the tensile strand and optionally a further interply is/are reinforced with fibers.

26. The drive belt according to claim 25, wherein the fibers are textile fibers.

27. The drive belt according to claim 26, wherein the fibers are selected from the group consisting of cotton, cellulose, aramid, polyamide (PA), polyvinyl acetal (PVA), and polyethylene terephthalate (PET), or a mixture thereof.

28. The drive belt according to claim 25, wherein the fibers are present in the form of a pulp or in short fibers.

29. The drive belt according to claim 28, wherein the short fibers have a length ≦8 mm.

30. The drive belt according to claim 29, wherein the short fibers have a length ≦5 mm.

31. The drive belt according to claim 1, wherein the top ply and/or the force transmission zone of the substructure is/are provided with a coating.

32. The drive belt according to claim 31, wherein the coating comprises a textile cover ply.

33. The drive belt according to claim 32, wherein the textile cover ply is a woven fabric, a loop-formingly knitted fabric or a loop-drawingly knitted fabric.

34. The drive belt according to claim 31, wherein the coating comprises a fluororubber.

35. The drive belt according to claim 34, wherein the fluororubber is selected from the group consisting of polytetrafluoroethylene (PTFE), polyvinyl fluoride (PVF), and polyvinylidene fluoride (PVDF), or a mixture thereof.

36. The drive belt according to claim 35, wherein the fluororubber is PTFE.

37. The drive belt according to claim 1, wherein the drive belt is configured as a V-ribbed belt.

38. The drive belt according to claim 37, the V-ribbed belt being a V-ribbed belt for a V-ribbed belt drive without automatic tensioning system.
